(19) United States
(12) Patent Application Publication
(10) Pub. No.: US 2026/0318140 A1
(43) Pub. Date: Oct. 15, 2026

(54) FOLDING HYDRAULIC DOOR

(71) Applicant: MICHAEL L. SCHWEISS, HECTOR, MN (US)

(72) Inventor: MICHAEL L. SCHWEISS, HECTOR, MN (US)

(21) Appl. No.: 19/637,942

(22) Filed: Apr. 2, 2026

Related U.S. Application Data
(60) Provisional application No. 63/786,090, filed on Apr. 9, 2025.

(51) Int. Cl. E05F 15/51

(52) U.S. Cl. CPC E05F 15/51; E05Y 2201/426; E05Y 2201/454; E05Y 2201/64; E05Y 2201/688; E05Y 2900/108; E05Y 2900/132

(57) ABSTRACT

An overhead door frame assembly has a horizontal header connected to channel shaped columns accommodating hydraulic lifting cylinders. Each hydraulic lifting cylinder is attached to a door truck and located in the channel of each column. Hinges pivotally mount the overhead door to the header to allow hydraulic lifting cylinders to move the overhead foldable door between an inwardly folded open position and a closed position.

### CROSS REFERENCE TO RELATED APPLICATION

This application claims the priority of U.S. Provisional Application Ser. No. 63/786,090 filed Apr. 9, 2025.

### FIELD OF INVENTION

The folding hydraulic door is in the art relating to structures operable to close and open openings and doorways of buildings. The door is a large two-piece door supported on a frame assembly and movable with hydraulic cylinders between an open folded position and a closed positions relative to the doorway of the building allowing aircraft, vehicles and equipment to be moved through the doorway into and out of the building.

### BACKGROUND OF THE INVENTION

Commercial, industrial and recreational buildings, aircraft hangers, restaurants, sports stadiums, farm equipment, marine and vehicle holding structures, and warehouses have over-sized large openings and doorways that are opened and closed with large and heavy doors. Overhead doors are used to maximize useable space of the doorways. Frame assemblies are employed to support the overhead doors independently of the building structure. Examples of overhead doors supported on frame assemblies and selectively moveable with hydraulic cylinders to open positions and closed positions are identified in the following U.S. patents.

K. O. Jonsson in U.S. Pat. No. 3,464,161 discloses a garage having a swingable door mounted in a building frame having two vertical posts. Horizontal support arms secured to the posts are pivotally connected to moveable arms attached to the door. Piston and cylinder units pivotally connected to the support arms and the moveable arms balance the door so that the net force required to open and close the door is small. The entire weight of the door is subjected to the two vertical posts.

D. J. Kerkvliet in U.S. Pat. No. 6,883,273 discloses an overhead door pivotally connected to a framework that is separate from a building structure. The framework has a horizontal member secured to vertical members. The vertical members are steel tubes secured with welds to opposite ends of the horizontal member. Hinges pivotally support the overhead door on the horizontal member. Hydraulic cylinders connected to the vertical members and overhead door are operable to move the overhead door between an upright closed position and a horizontal open position. The weight of the overhead door, the wind forces and the hydraulic cylinder forces subjected to the overhead door are transferred to the upright members.

D. Crown and P. Crown in U.S. Pat. No. 8,714,229 disclose two hydraulic cylinders mounted on opposite sides of a building door frame operable to open and close an overhead bi-fold door. Hinges pivotally mount the door to the horizontal member of the door frame. Each hydraulic cylinder is pivotally mounted on the door frame below the axis of rotation of the overhead door and attached to a side edge of the overhead door. The overhead door and the two hydraulic cylinders pivotally connected to the building door frame subject the building door frame to the overhead door weight and the forces of the hydraulic cylinders that move the overhead door between the closed position and the open position.

R. W. Betker in U.S. Pat. No. 8,245,446 discloses a tilt-up one-piece door supported on channel members for movement by hydraulic cylinders to a closed position and an open position. The hydraulic cylinders are anchored to the channel members and pivotally connected to the door. The hydraulic cylinders are operable to tilt the door between an upright closed position and a horizontal open position. Upright I-beams are disclosed as supports for a horizontal track supporting the tilt-up door. The horizontal track controls the tilting movements of the tilt-up door.

R. Peterson in U.S. Patent Application Publication No. US2011/0225895 discloses an overhead door pivotally connected with hinges to a horizontal header of a frame assembly. The frame assembly includes upright posts attached to opposite ends of the header that are located adjacent opposite sides of a doorway. The posts are tube stock material. U-shaped channel members secured to the header telescope into the tube posts to connect the header to the posts. Hinges at opposite ends of the header pivotally connect the overhead door to the header. Hydraulic cylinders connected to the posts and overhead door are operable to pivot the overhead door between an upright closed position and a horizontal open position. All the weight of the overhead door and the forces of the hydraulic cylinders that open and close the overhead door are subjected to the upright posts.

R. E. Peterson in U.S. Pat. No. 11,549,294 discloses an overhead door system used to selectively close an opening in a structure having a relatively wide door leaf operably mounted on a door frame for movement between a closed configuration and an open configuration. A hydraulic cylinder operably connects the door leaf to the door frame to facilitate moving the door leaf between the closed configuration and the open configuration. The hydraulic cylinder is substantially recessed in a slot in the frame and a slot located between the front and back surfaces of the door leaf when the door leaf is in the closed configuration.

M. L. Schweiss in U.S. Pat. Nos. 10,316,576 and 10,604,991 discloses the combination of an overhead door and a frame assembly for supporting the overhead door for movement between an upright closed position and a horizontal open position relative to a doorway of a building. The frame assembly has a horizontal header attached with splice assemblies to two upright columns. Each column is a single upright tubular member. Hinges pivotally connect the overhead door to the header to allow hydraulic cylinders to move the overhead door between the upright closed position and the horizontal open position and allow the overhead door to move from the horizontal open position to the upright closed position. The weight of the over door, wind forces and forces of the hydraulic cylinders on the overhead door are subjected to the two upright columns.

### SUMMARY OF THE INVENTION

The foldable door of the invention is operable to be moved with linear actuators between an upright closed position and a horizontal inwardly folded open position. The frame assembly has a horizontal header supported by upright columns. The upright columns are attached to opposite ends of the header whereby the columns are aligned with the header and maintained straight, flush and in the same upright plane as the header. A plurality of hinge assemblies pivotally connects the door frame to the header. Linear actuators, such as hydraulic cylinders, connected to the upright columns and the door operate to move the door between an upright closed position and a horizontal folded open position and allow the door to move from the horizontal folded open position to the upright closed position with reduced clearance. The frame assembly supports the weight of the door and absorbs wind forces and the forces subjected to the door by the linear actuators during the opening and closing of the door thereby eliminating most if not all weight and forces on the adjacent building structure.

### DESCRIPTION OF THE DRAWING

FIG. 1 is a perspective view of a building equipped with an open overhead foldable door closing a doorway in a side wall of the building;

FIG. 2 is a perspective view of the building of FIG. 1 showing the overhead foldable door in a folded open position above the doorway of the building;

FIG. 3 is an inside elevational view of the overhead foldable door in the closed position connected to a freestanding header;

FIG. 4 is a perspective view of the open overhead foldable door frame;

FIG. 5 is an enlarged sectional view taken along line 5-5 of FIG. 4;

FIG. 6 is a sectional view similar to FIG. 5 showing the overhead foldable door in various positions between the upright closed position and the inwardly folded open position;

FIG. 7 is an enlarged foreshortened view of the column and lifting cylinder of the overhead foldable door;

FIG. 8 is an enlarged perspective view of the door truck of the overhead foldable door; and

FIG. 9 is an enlarged side view of the door truck of FIG. 8.

### DETAILED DESCRIPTION OF THE OVERHEAD DOOR

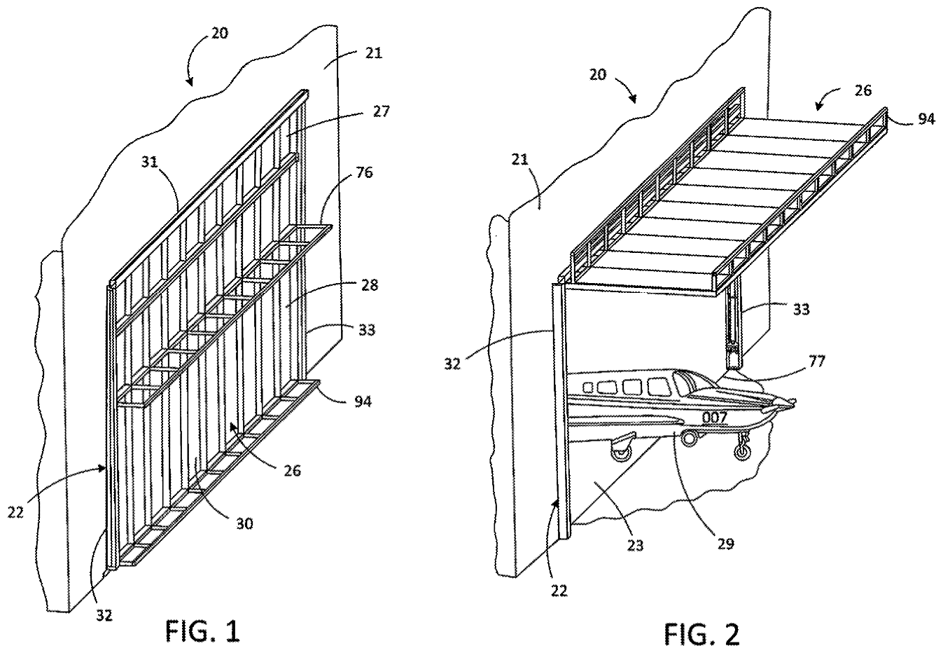

As shown in FIG. 1, a building 20, such as an aviation hanger, agricultural building, warehouse, industrial building and like structure, has an upright side wall 21 having an opening or doorway 23 providing access to the interior of building 20. A foldable door 26, shown as an overhead folding bi-fold door, is located in an upright closed position to close doorway 23. Foldable door 26 has upper and lower sections or panels 27 and 28. Upper panel 27 is pivotally connected to a free standing header 22 located in doorway 23 for movement between an upright vertical closed position, as seen in FIG. 1, and an overhead horizontal folded open position, shown in FIG. 2, to enable a vehicle 29 to maneuver through doorway 23.

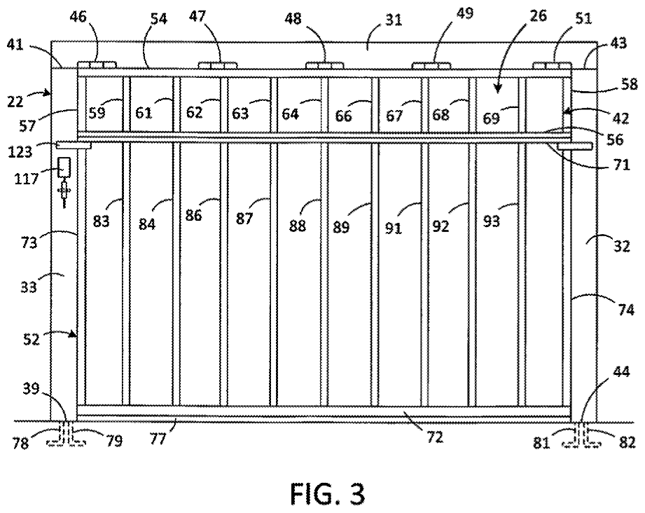

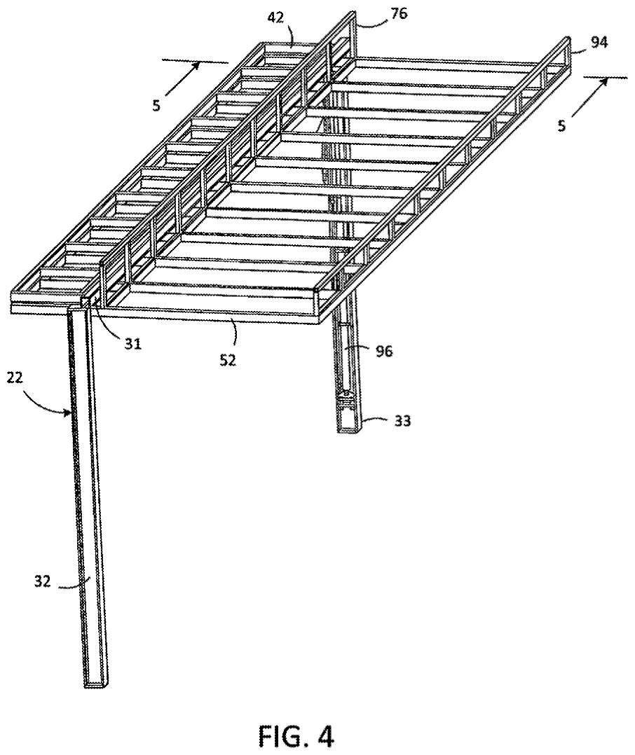

Referring to FIG. 3, the inside or back elevational view of foldable door 26 in its upright closed position is shown. Header 22 is attached to and supports foldable door 26 providing a sturdy and level structure for door 26 whereby the frame of building 20 is not subjected to horizontal loads foldable door 26 exerts on header 22 when door 26 is in its overhead folded open position. Building 20 can also be constructed with headers having vertical and horizontal strength to support foldable door 26.

Header 22 comprises a top horizontal header member 31 and upright legs or columns 32 and 33. Header member 31 is a square metal tube. Columns 32 and 33 are metal beams each having an I-shaped cross section. Columns 32 and 33 each have a pair of horizontal flanges 34 and 36, a vertical web 37, upper closed ends 41 and 43 and lower closed ends 39 and 44 defining a hollow interior channel shaped section 38 located adjacent the sides of foldable door 26. Upper ends 41 and 43 of columns 32 and 33 are attached to the bottom surface of the opposite ends of header member 31 whereby the vertical load of foldable door 26 on header member 31 is directly transmitted to columns 32 and 33. Columns 32 and 33 can be welded to header member 31. Bottom ends 39 and 44 of columns 32 and 33 are connected to anchors 78, 79, 81 and 82 that support header 22 on floor 77.

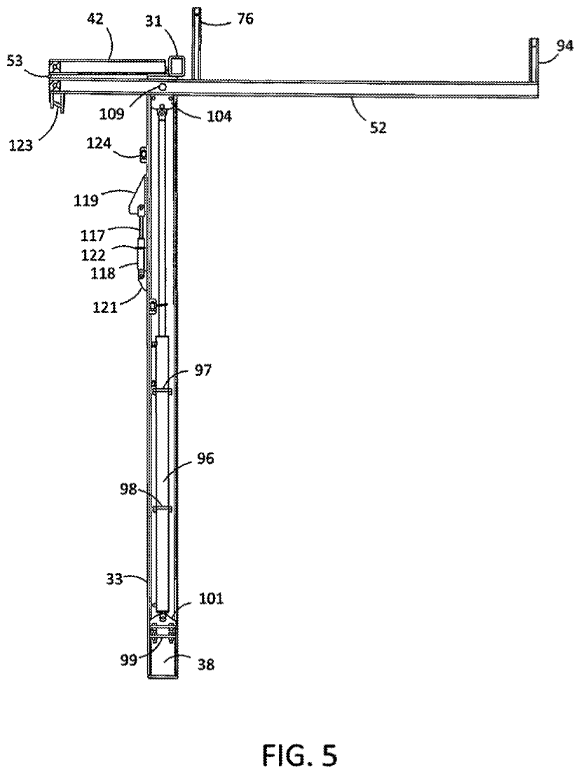

As shown in FIGS. 3 and 5, foldable door 26 has an upper frame 42 and a lower frame 52. Clear sheathing 30 is attached to upper and lower frame members 42 and 52 with fasteners or an adhesive. Other types of sheathing can be used to cover upper and lower frame members 42 and 52 of foldable door 26. Upper frame 42 and lower frame 52 are pivotally connected with hinges 53 to allow upper frame 42 and lower frame 52 to pivot in arcuate paths between an upright closed position, shown in FIG. 1, and a horizontal side-by-side inwardly folded open position, shown in FIG. 2. Upper frame 42 has a transverse top member 54 and a transverse bottom member 56. Upright end members 57 and 58 are secured to opposite ends of top and bottom members 54 and 56. Upright members 59, 61, 62, 63, 64, 66, 67, 68 and 69 are located between end members 57 and 58 are secured to transverse top member 54 and transverse bottom member 56. Members 54, 56, 57, 58, 59, 61, 62, 63, 64, 66, 67, 68 and 69 are tubular metal stock secured together to form a strong and rigid one-piece upper frame.

Lower frame 52 has a horizontal top member 71 and a horizontal bottom member 72. Upright end members 73 and 74 are secured to opposite ends of horizontal top member 71 and horizontal bottom member 72. Upright members 83, 84, 86, 87, 88, 91, 92 and 93 located between upright end members 73 and 74 are secured to opposite ends of top and bottom members 71 and 72. A first transverse truss member 76 located between horizontal top member 71 and horizontal bottom member 72 is secured to upright end members 73 and 74. A second transverse truss member 94 secured to end members 73 and 74 and horizontal bottom member 72 is located below first transverse truss member 76. First transverse truss member 76 and second transverse truss member 94 extend outwardly from and perpendicular to lower frame 52 of foldable door 26 to give foldable door 26 stability. Second transverse truss 94 is located parallel to horizontal bottom member 72 and inhibits bending and deflection of horizontal bottom member 72. Hinges 46, 47, 48, 49 and 51 pivotally connect top member 54 of upper frame 42 to horizontal header member 31 of header 22. Hinges 46, 47, 48, 49 and 51 enable upper and lower panels 27 and 28 of foldable door 26 to pivot inwardly relative to parallel horizontal axes between an upright vertical closed position, shown in FIGS. 1 and 3, and an inwardly folded open position, as seen in FIG. 2, whereby upper panel 27 and the top section of lower panel 28 above second transverse truss member 94 are located on the interior of building 20.

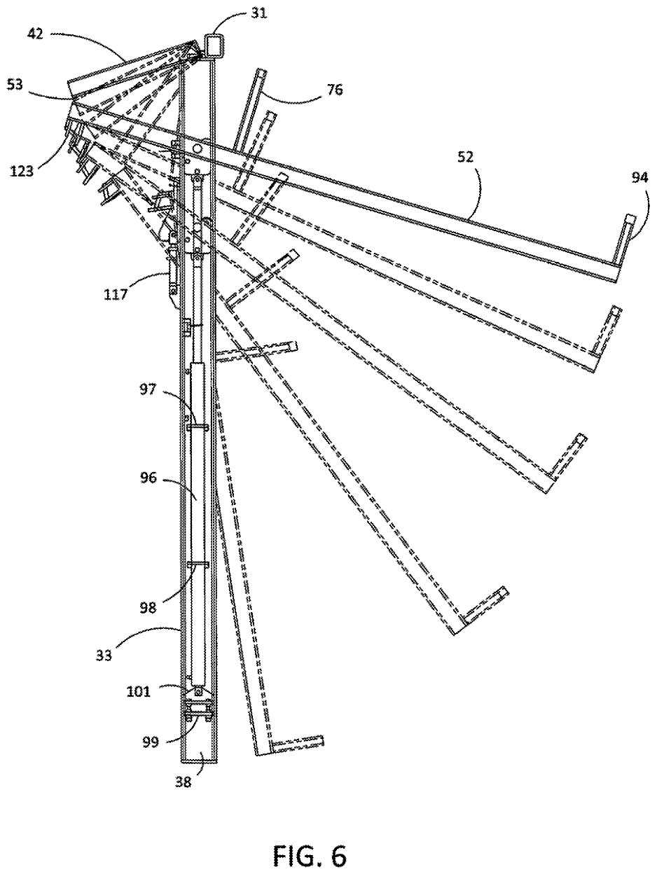

Foldable door 26 is moved between the inwardly folded open position and the upright vertical closed position with door lift devices or linear actuators, such as hydraulic lifting cylinder 96. When hydraulic lifting cylinder 96 moves foldable door 26 to the inwardly folded open position upper frame 42 pivots upward and inward, top section of bottom frame 52 pivots upward and inward adjacent upper frame 42, and the bottom section of bottom frame 52 pivots upward and outward, as seen in FIG. 6, thereby reducing the clearance needed when opening foldable door 26. Conversely, when hydraulic lifting cylinder 96 moves foldable door 26 to the upright vertical closed position upper frame 42 pivots downward and outward, the top section of bottom frame 52 pivots downward and outward away from upper frame 42, and the bottom section of bottom frame 52 pivots downward and inward thereby reducing the clearance needed when maneuvering foldable door 26 to the closed position. First and second transverse truss members 76 and 94 mounted on the outside of foldable door 26 prevent sagging of door 26 when door 26 is in the inwardly folded open position. Truss members 76 and 94 do not interfere with building 20 when foldable door 26 is in the inwardly folded open position.

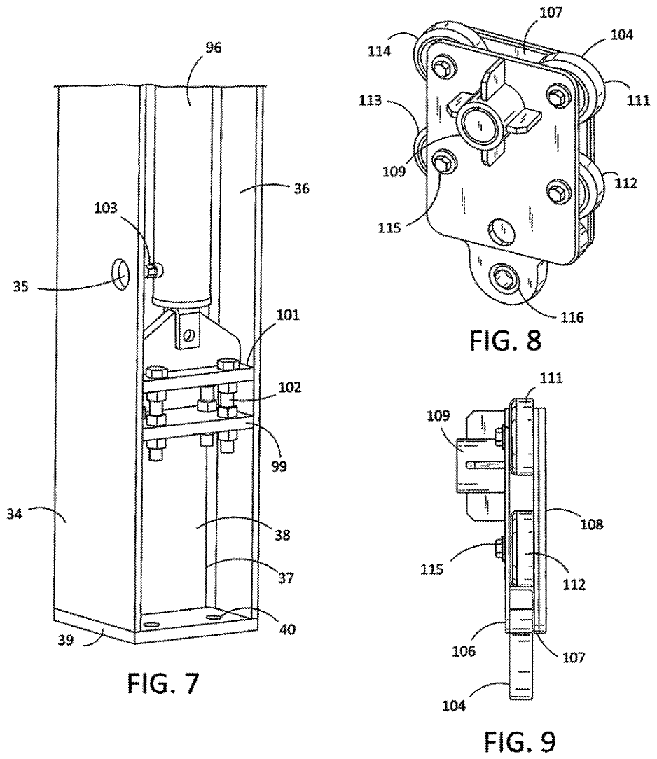

Hydraulic lifting cylinder 96 is located upright in hollow interior section 38 of column 33 and secured to column 33. A hydraulic lifting cylinder identical in structure and function to hydraulic lifting cylinder 96 is located upright in the hollow interior section of column 32. The details of hydraulic lifting cylinder 96 secured to column 33, shown in FIG. 7, are included in the hydraulic lifting cylinder secured to column 32. Cylinder mounts 99 and 101 connect hydraulic lifting cylinder 96 to column 33 and support hydraulic lifting cylinder 96 within hollow interior section 38. Lower cylinder mount 99 is secured or welded to flanges 34 and 36 and web 37 of column 33. Flange 34 has an opening 35 to access flow port 103 of hydraulic lifting cylinder 96 located above cylinder mounts 99 and 101. Upper cylinder mount 101 supports the lower end of hydraulic lifting cylinder 96. Upper cylinder mount 101 is bolted to lower cylinder mount 99 with bolts 102 to allow for height adjustment of hydraulic lifting cylinder 96 within hollow interior section 38 of column 33. Bolts 102 are adjustable to adjust the height of upper cylinder mount 101 and the space between upper cylinder mount 101 and lower cylindrical mount 99 as needed to adjust the height of hydraulic lifting cylinder 96. Brackets 97 and 98 attached to column 33 extend over the body of hydraulic lifting cylinder 96 to hold hydraulic lifting cylinder 96 on column 33.

A door truck 104 is attached to the outer end of piston rod 126 of hydraulic lifting cylinder 96. Door truck 104 has a lower end 105 having a cylindrical mount spherical bearing 116 to mount door truck 104 on hydraulic lifting cylinder 96. As seen in FIGS. 5, 8 and 9, door truck 104 is a rectangular shaped member having substantially the same width as the inside width of column 33. Door truck 104 has a rectangular front plate 106 and a rectangular back plate 107 equal in size to front plate 106. A plurality of roller bearings 111, 112, 113 and 114 are rotatably mounted with fasteners 115 between front plate 106 and back plate 107. Roller bearings 111, 112, 113 and 114 extend outwardly from front plate 106 and back plate 107 and are configured to ride along flanges 34 and 36 of column 33 upon actuation of hydraulic lifting cylinder 96 to extend and contract piston rod 126 and open and close door 26. A slide plate 108 attached to the outer surface of back plate 107 slidably engages web 37 of column 33 upon movement of door truck 104 within interior section 38 of column 33. Slide plate 108 is preferably a polytetrafluoroethylene plate having a low friction surface to facilitate sliding of slide plate 108 on web 37 and reduce friction, wear and energy consumption of hydraulic lifting cylinder 96. Slide plate 108 can have other types low friction slippery outer surfaces. Door truck 104 has a bushing 109 configured to pivotally connect door truck 104 to lower frame 52 below the axis of rotation of hinges 53 pivotally connecting upper frame 42 to lower frame 52. Bushing 109 is preferably a self-lubricating bushing, such as oil-embedded bushing. Other types of bushings can be used to pivotally connect lower frame 52 to door truck 104.

A hydraulic breaker 117 mounted on column 33 is operable to break and bias foldable door 26 to fold inwardly into the inside of building 20 upon initiation of movement of foldable door 26 from the closed position. Hydraulic breaker 117 has a cylinder 118 attached to a wedge shaped head 119 having an inclined outer surface. A receptacle 123 is attached to the top section of lower panel 28 of foldable door 26 adjacent horizontal frame member 71. Receptacle 123 has an inclined inner surface complimentary to the inclined outer surface of head 119. Hydraulic breaker 117 is actuated to extend head 119 into receptacle 123 as hydraulic lifting cylinder 96 is operated to move door 26 from the closed position whereby upper and lower panels 27 and 28 break and fold inwardly into the inside of building 20. As upper and lower panels 27 and 28 of door 26 break and fold inwardly receptacle 123 and head 119 disengage. A stop 124 secured to column 33 limits upward movement of head 119.

The foregoing drawing and description of the folding hydraulic door with channel shaped columns and truck assemblies is one embodiment of the invention. Persons skilled in the art of hydraulic doors can make changes and modifications of the structures and materials to the door, truck assemblies and hinges without departing from the folding hydraulic door defined in the claims.

1. A combination of a door and an apparatus for opening and closing the door to upright columns of a structure located adjacent a door opening comprising:
a foldable door having an upper panel, a lower panel and hinges pivotally connecting the upper and lower panels to allow the upper and lower panels to move between an aligned closed vertical position and an inwardly folded side-by-side open horizontal position,
the upper panel configured to be located inside of the structure when the foldable door is in the inwardly folded side-by-side open horizontal position,
door lift devices operable to selectively move the upper and lower panels between the aligned closed vertical position and the inwardly folded side-by-side open horizontal position,
each of the door lift devices having a linear actuator, the linear actuator having a first end and a second end,
a first mount mounted on a respective upright column of the structure attached to the first end of the linear actuator,
a second mount secured to the respective upright column fastened to the first mount,
a door truck rotatably connected to the lower panel connected to the second end of the linear actuator whereby upon actuation of the linear actuator the door truck moves the upper and lower panels between the aligned closed vertical position and the inwardly folded side-by-side open horizontal position.

2. The combination of claim 1 wherein:
the first mount is fastened to the second mount with adjustable fasteners to allow for height adjustment of the linear actuator.

3. The combination of claim 1 wherein:
the door truck has a plurality of roller bearings configured to ride along the respective upright column upon actuation of the linear actuator.

4. The combination of claim 1 wherein:
the door truck has a slide plate configured to slidably engage the respective upright column upon actuation of the linear actuator.

5. The combination of claim 1 including:
a breaker secured to the respective upright column configured to bias and break the foldable door inwardly upon actuation of the linear actuator.

6. An apparatus for opening and closing an opening in a structure with a foldable door mounted on an upright column of the structure for movement between a closed position and an open inwardly folded position comprising:
a door lift assembly operable to selectively move the foldable door between the closed position and the open inwardly folded position,
the door lift assembly having a hydraulic lifting cylinder,
a door truck rotatably connected to the foldable door connected to the second end of the hydraulic lifting cylinder, and
a hydraulic breaker secured to the upright column configured to bias and break the foldable door inwardly whereby upon actuation of the hydraulic lifting cylinder the hydraulic breaker biases and breaks the foldable door inwardly and the door truck moves the foldable door between the closed position and the open inwardly folded position.

7. The apparatus of claim 6 wherein:
the hydraulic lifting cylinder has a first end and a second end opposite the first end,
a first mount plate mounted on the upright column of the structure attached to the first end of the hydraulic lifting cylinder, and
a second mount plated secured to the upright column fastened to the first mount.

8. The apparatus of claim 7 wherein:
the first mount is fastened to the second mount with adjustable fasteners to allow for height adjustment of the hydraulic lifting cylinder.

9. The apparatus of claim 6 wherein:
the door truck has a plurality of roller bearings configured to ride along the upright column upon actuation of the hydraulic lifting cylinder.

10. The apparatus of claim 6 wherein:
the door truck has a slide plate configured to slidably engage the upright column upon actuation of the hydraulic lifting cylinder.

11. An overhead foldable door for selectively opening and closing a doorway of a structure comprising:
a first panel having a first frame,
the first frame having a first upper frame member and a first lower frame member located opposite the first upper frame member,
a plurality of first hinges pivotally connecting the first upper frame member to the structure to pivotally connect the first panel to the structure,
a second panel having a second frame,
the second frame having a second upper frame member and a second lower frame member located opposite the second upper frame,
a plurality of second hinges pivotally connecting the first lower frame member to the second upper frame member to pivotally connect the first panel to the second panel,
the plurality of first hinges and the plurality of second hinges operable to allow the first panel and the second panel to be moved between an aligned upright position closing the doorway and a side-by-side inwardly folded position opening the doorway, and
a door lift device operable to selectively move the first panel and the second panel from the aligned upright position to the side-by-side inwardly folded position opening the doorway whereby the first panel and an upper portion of the second panel are located inside the structure and selectively move the first panel and the second panel from the side-by-side inwardly folded position to the aligned upright position closing the doorway.

12. The overhead foldable door of claim 11 wherein:
the door lift device has a linear actuator,
the linear actuator mounted on an adjustable mounting plate assembly configured to adjust the linear actuator to a selected height attached to the structure.

13. The overhead foldable door of claim 12 wherein:
the adjustable mounting plate assembly has a first mount plate attached to the linear actuator and a second mount plate secured to the structure fastened to the first mount plate,
the first mount plate being fastened to the second mount plate with adjustable fasteners to allow for height adjustment of the linear actuator.

14. The overhead foldable door of claim 11 including:
a breaker assembly secured to the structure configured to bias and break the first panel and the second panel inwardly when the first and second panels are moved from the aligned upright position closing the doorway.

15. The overhead door of claim 11 including:
a door truck rotatably connected to the lower panel connected to the linear actuator whereby upon actuation of the linear actuator the door truck moves the upper and lower panels between the aligned closed vertical position and the inwardly folded side-by-side open horizontal position.

16. The overhead foldable door of claim 11 including:
sheathing attached to the first frame and the second frame.

17. A door for closing a doorway in a building having a horizontal header and upright columns located around the doorway comprising:
a foldable door having an upper panel and a lower panel pivotally connected to the upper panel to allow the upper and lower panels to move between an aligned upright position closing the doorway and an inwardly folded side-by-side position opening the doorway,
at least one hinge for pivotally connecting the upper panel to the horizontal header,
door lift devices operable to move the upper and lower panels between the aligned upright position and the inwardly folded side-by-side position,
each of the door lift devices having a linear actuator, the linear actuator having a first end and a second end,
a mount secured to a respective upright column attached to the first end of the linear actuator,
a door truck rotatably connected to the lower panel connected to the second end of the linear actuator whereby upon actuation of the linear actuator the door truck moves the upper and lower panels between the aligned closed vertical position and the inwardly folded side-by-side open horizontal position.

18. The door of claim 17 wherein:
each of the upright columns having an interior section, the linear actuator mounted in the interior section.

19. The door of claim 17 wherein:
the mount has a first mount plate mounted on the respective upright column attached to the first end of the linear actuator,
a second mount plate secured to the respective upright column fastened to the first mount plate,
the first mount plate being fastened to the second mount plate with adjustable fasteners to allow for height adjustment of the linear actuator.

20. The door of claim 17 wherein:
the door truck has a plurality of roller bearings configured to ride along the respective upright column upon actuation of the linear actuator.

21. The door of claim 17 wherein:
the door truck has a slide plate configured to slidably engage the respective upright column upon actuation of the linear actuator.

22. The combination of claim 17 including:
a breaker secured to the respective upright column configured to bias and break the upper and lower panels inwardly upon actuation of the linear actuator.

23. In combination:
a foldable door,
a frame assembly for supporting the foldable door for movement between an inwardly folded open position and a closed position,
the frame assembly having a horizontal header located in an upright plane,
the horizontal header having a first end and a second end located opposite the first end,
a first upright column having a first interior section and a first upper end connected to the first end of the horizontal header,
a second upright column having a second interior section and a second upper end connected to the second end of the horizontal header,
a plurality of hinge assemblies pivotally connecting the foldable door to the horizontal header for pivotal movement of the foldable door between the inwardly folded open position and the door closed position, and
a first linear actuator operably connected to the first upright column and the foldable door,
the first linear actuator mounted in the first interior section of the first upright column,
a second linear actuator operably connected to the second upright column,
the second linear actuator mounted in the second interior section of the second upright column,
the first linear actuator and the second linear actuator operable to selectively move the foldable door relative to the frame assembly between the door inwardly folded open position and the door closed position.

24. The combination of claim 23 including:
a first door truck secured to the first linear actuator pivotally connected to the foldable door, and
a second door truck secured to the second linear actuator pivotally connected to the foldable door opposite the first door truck.

25. The combination of claim 24 wherein:
the first door truck has a plurality of first roller bearings configured to ride along the first upright column upon actuation of the first linear actuator,
the second door truck having a plurality of second roller bearings configured to ride along the second upright column upon actuation of the second linear actuator.

26. The combination of claim 24 wherein:
the first door truck has a first slide plate configured to slidably engage the first upright column upon actuation of the first linear actuator,
the second door truck having a second slide plate configured to slidably engage the first upright column upon actuation of the second linear actuator.

27. The combination of claim 24 including:
a breaker secured to one of the first upright column or the second upright column configured to bias the foldable door to fold inwardly upon actuation of the first linear actuator and the second linear actuator.
